(19) United States
(12) Patent Application Publication
(10) Pub. No.: US 2026/0235454 A1
(43) Pub. Date: Aug. 13, 2026

(54) HEAT FLUX ACQUISITION DEVICE, HEAT FLUX ACQUISITION SYSTEM, AND HEAT FLUX ACQUISITION METHOD OF FURNACE

(71) Applicant: CHIYODA CORPORATION, Yokohama-shi, Kanagawa (JP)

(72) Inventor: Ashfak Junichiro KAZI, Kanagawa (JP)

(21) Appl. No.: 19/155,476

(22) PCT Filed: Feb. 20, 2023
(86) PCT No.: PCT/JP2023/005898

§ 371 Date: Aug. 11, 2025

(51) Int. Cl. G01K 17/00; F27D 21/00

(52) U.S. Cl. CPC G01K 17/00; F27D 21/0014

(57) ABSTRACT

[TASK] To easily acquire a local heat flux at a target point in a furnace.

[SOLUTION] The heat flux acquisition device 4 includes a processor configured to execute a process to acquire heat flux of a target object 12 in a furnace 2. The processor is configured to acquire a target point temperature measured by a temperature sensor 23 at a target point on an outer surface of the target object 12, acquire an ambient temperature corresponding to the target point, and calculate a local heat flux at the target point based on the target point temperature and the corresponding ambient temperature.

### TECHNICAL FIELD

The present invention relates to a heat flux acquisition device, a heat flux acquisition system, and a heat flux acquisition method for acquiring heat flux of a target object in a furnace.

### BACKGROUND ART

A conventional method for estimating an outer surface temperature of a coil in an ethylene production cracking furnace is known, in which even when a relatively high temperature area exists within an imaged area, the temperature of the area is reflected to estimate the outer surface temperature of the coil (see Patent Document 1). In this conventional method, an imaging camera for capturing the target area of the coil is used, which may be a color video camera that outputs the luminance at each photosensitive pixel for each RGB wavelength, a monochrome video camera that measures the luminance at a single wavelength between 1 μm and less than 3 μm, or a two-sensor camera that measures the ratio of the luminance at a first wavelength and a second wavelength between 1 μm and less than 3 μm.

Further, a method for measuring radiative heat flux on an external surface of a building is known, in which the radiative heat flux on the external surface of the building is quantitatively measured based on infrared imaging technology (see Patent Document 2). In this conventional method, the net radiative heat flux on the external surface of the building is acquired by capturing infrared thermographic images and analyzing the captured images.

### PRIOR ART DOCUMENT(S)

### Patent Document(s)

Patent Document 1: Japanese Patent No. 7111583B
Patent Document 2: China Patent Application Publication No. 113970388A

### SUMMARY OF THE INVENTION

### Task to be Accomplished by the Invention

In the furnace used as a plant facility, the heat flux related to the heating tube and the like is an important index related to various phenomena occurring in the furnace (for example, the occurrence of coking and film boiling).

Meanwhile, although methods for estimating or measuring the temperature or heat flux of a target object using a camera or the thermographic device, such as the conventional techniques described in Patent Documents 1 and 2, are known, a method for easily acquiring the heat flux (i.e., the local heat flux) at the desired position of the target object in the furnace is not yet widely available.

In view of the above background, an object of the present invention is to provide a heat flux acquisition device, a heat flux acquisition system, and a heat flux acquisition method that can easily acquire local heat flux of a target object in a furnace.

### Means to Accomplish the Task

To achieve such an object, one aspect of the present invention provides a heat flux acquisition device (4) for acquiring heat flux of a target object (12) in a furnace (2), the heat flux acquisition device comprising a processor configured to execute a process to acquire the heat flux of the target object, and the processor is configured to: acquire a target point temperature measured by a temperature sensor (23) at a target point on an outer surface of the target object; acquire an ambient temperature corresponding to the target point; and calculate a local heat flux at the target point based on the target point temperature and the corresponding ambient temperature.

According to this aspect, it is possible to easily acquire the local heat flux of the target object in the furnace.

In the above aspect, preferably, the local heat flux is calculated based on energy radiated toward the target object and calculated based on the ambient temperature, and energy radiated from the target object and calculated based on the target point temperature.

According to this aspect, it is possible to easily calculate the local heat flux of the target object in the furnace based on the ambient temperature and the target point temperature.

In the above aspect, preferably, the furnace is a tubular furnace (2), and the target object includes a heating tube (12) of the tubular furnace.

According to this aspect, it is possible to easily acquire the local heat flux of the heating tube in the furnace.

In the above aspect, preferably, the ambient temperature is an estimated ambient temperature estimated based on the corresponding target point temperature in a measurement at the target point by a thermographic device (22).

According to this aspect, it is possible to improve the accuracy of the ambient temperature by acquiring the ambient temperature estimated based on the measurement of the target point by the thermographic device (i.e., the estimated ambient temperature).

In the above aspect, preferably, the ambient temperature is a corrected ambient temperature acquired by calculation, the heating tube includes one or more segments (G₁-G₉) and a plurality of target points (P₁₋₁-P₁₋₈) set for each segment, and the corrected ambient temperature is calculated based at least on the target point temperatures measured by the temperature sensor at each target point, heat quantity of heated fluid flowing into the heating tube, and heat quantity of the heated fluid flowing out of the heating tube.

According to this aspect, it is possible to easily improve the accuracy of the ambient temperature by acquiring the ambient temperature corrected based on the heat quantity of the heated fluid (i.e., the corrected ambient temperature).

In the above aspect, preferably, the processor is configured to: acquire each target point temperature; acquire an estimated ambient temperature in the furnace corresponding to each segment, the estimated ambient temperature being estimated based on each corresponding target point temperature; calculate an estimated local heat flux at each target point based on each target point temperature and the corresponding estimated ambient temperature; calculate an estimated segment average heat flux or an estimated segment heat input for each segment based on the estimated local heat flux, and acquire an estimated average heat flux or an estimated heat input for the heating tube based on the estimated segment average heat flux or the estimated segment heat input; calculate an actual average heat flux or an actual heat input for the heating tube based on the heat quantity of the heated fluid flowing into the heating tube and the heat quantity of the heated fluid flowing out of the heating tube; and calculate the corrected ambient temperature by correcting the estimated ambient temperature so that the estimated average heat flux matches the actual average heat flux, or so that the estimated heat input matches the actual heat input.

According to this aspect, it is possible to improve the accuracy of the ambient temperature by calculating a corrected ambient temperature (i.e., the corrected ambient temperature) based on the heat flux or heat input for each segment based on each target point temperature and the corresponding estimated ambient temperature (i.e., an estimated segment heat flux or the estimated segment heat input), and the heat flux or heat input based on the heat quantity of the heated fluid (i.e., the actual average heat flux or the actual heat input).

In the above aspect, preferably, each segment includes a subsegment (G₁₋₁-G₁₋₈) corresponding to each target point, and the processor is configured to calculate the estimated segment average heat flux for each segment based on a weighted average using a surface area (S₁₋₁-S₁₋₈) of each subsegment as a weight for the local heat flux at the corresponding target point.

According to this aspect, it is possible to accurately acquire the heat flux for each segment by considering the surface area of each subsegment corresponding to each target point.

In the above aspect, preferably, the heating tube includes a plurality of segments including one representative segment and a subordinate segment other than the representative segment, the estimated ambient temperature of the subordinate segment is expressed using a temperature ratio relative to the estimated ambient temperature of the representative segment, and the processor is configured to: calculate a corrected ambient temperature of the representative segment; and calculate a corrected ambient temperature of the subordinate segment based on the corrected ambient temperature of the representative segment and the temperature ratio.

According to this aspect, it is possible to easily acquire the corrected ambient temperature for each segment since the corrected ambient temperature of the subordinate segment is calculated based on the corrected ambient temperature of the representative segment.

In the above aspect, preferably, the heat flux acquisition device further comprises a storage device (32) configured to store the temperature ratio between the estimated ambient temperature of the subordinate segment and the estimated ambient temperature of the representative segment.

According to this aspect, it becomes easier to use the temperature ratio between the estimated ambient temperature of the subordinate segment and the estimated ambient temperature of the representative segment.

In the above aspect, preferably, the processor is configured to: acquire each target point temperature; acquire the corrected ambient temperature of the representative segment and the corrected ambient temperature of the subordinate segment; calculate the local heat flux at the target point based on the target point temperature, and the corresponding corrected ambient temperature of the representative segment and the corresponding corrected ambient temperature of the subordinate segment.

According to this aspect, by using the previously acquired temperature ratio, the corrected ambient temperature of each subordinate segment can be easily calculated based on the corrected ambient temperature of the representative segment even if operating conditions of the furnace are changed, so that the load of the calculation process of the local heat flux at each target point is reduced.

In the above aspect, preferably, the processor is further configured to calculate the target point temperature at the target point based on the corrected ambient temperature of the representative segment and the corrected ambient temperature of the subordinate segment.

According to this aspect, it is possible to acquire the target point temperature without the need for measurement.

In the above aspect, preferably, the heat flux acquisition device further comprises a storage device (32), and the processor is further configured to: calculate an actual average heat flux for the heating tube based on heat quantity of a heated fluid flowing into the heating tube and heat quantity of the heated fluid flowing out of the heating tube; and calculate a heat flux ratio between the actual average heat flux and the local heat flux, and store the heat flux ratio in the storage device.

According to this aspect, it becomes easier to use the heat flux ratio between the actual average heat flux and the local heat flux.

In the above aspect, preferably, the processor is configured to: acquire the heat flux ratio stored in the storage device; calculate the actual average heat flux for the heating tube based on the heat quantity of the heated fluid flowing into the heating tube and the heat quantity of the heated fluid flowing out of the heating tube; and acquire the local heat flux based on the heat flux ratio and the actual average heat flux.

According to this aspect, by using the previously acquired heat flux ratio, the load of the calculation process of the local heat flux is reduced. In particular, it is advantageous that measurement of the target point temperature of the heating tube is unnecessary, and that neither the acquisition nor correction of the ambient temperature is necessary.

In the above aspect, preferably, the heat flux acquisition device further includes a storage device, and the processor is configured to: store operating conditions of the furnace and the ambient temperature under the operating conditions in the storage device; and construct a machine learning model that uses the operating conditions stored in the storage device as input and output the ambient temperature.

According to this aspect, by using the machine learning model that is constructed based on the previous operating conditions of the furnace and the ambient temperature under the operating conditions, it is possible to accurately acquire the ambient temperature corresponding to the current operating conditions (or the planned operating conditions).

In the above aspect, preferably, the processor is configured to: acquire the ambient temperature by inputting new operating conditions of the furnace into the machine learning model; and calculate the local heat flux based on the acquired ambient temperature and the target point temperature on the outer surface of the target object.

According to this aspect, it is possible to accurately calculate the local heat flux based on the ambient temperature acquired by the machine learning model.

In the above aspect, preferably, the operating conditions include combustion conditions of the furnace and operation conditions of a burner in the furnace.

According to this aspect, it is possible to accurately acquire the ambient temperature (and consequently the local heat flux) using the appropriate operating conditions.

In the above aspect, preferably, the temperature sensor includes a spectral radiation thermometer.

According to this aspect, even if the measurement is performed in a non-contact manner with respect to the target, it is possible to accurately acquire the target point temperature.

In the above aspect, preferably, the processor is configured to generate an image visualizing a distribution of the local heat flux.

According to this aspect, it is possible for the users to easily confirm various phenomena occurring in the furnace (for example, the occurrence of coking or film boiling) based on the image visualizing the distribution of the local heat flux.

In the above aspect, preferably, the heating tube includes one or more segments (G₁-G₉) and a plurality of target points set for each segment, and the processor is configured to acquire a temperature distribution of the target object measured by a thermographic device (32) using the estimated ambient temperature.

According to this aspect, it is possible to acquire a wide range of temperatures of the target objects in the furnace using the thermographic device.

In the above aspect, preferably, the processor is configured to acquire a temperature in the temperature distribution of the target object as the target point temperature.

According to this aspect, this increases the degree of freedom in setting the target point of the target object. In addition, the target point temperature can be easily acquired over a wide range of the target object.

To achieve such an object, one aspect of the present invention provides a heat flux acquisition system including the heat flux acquisition device. The heat flux acquisition system includes a spectral radiation thermometer (23) included in the temperature sensor, and a thermographic device (22) for acquiring the ambient temperature.

According to this aspect, it is possible to easily acquire the local heat flux of the target object in the furnace.

To achieve such an object, one aspect of the present invention provides a heat flux acquisition method for acquiring heat flux of a target object (12) in a furnace (2), the heat flux acquisition method including: acquiring, by a computer (4), a target point temperature measured by a temperature sensor (12) at a target point on an outer surface of the target object; acquiring, by the computer, an ambient temperature corresponding to the target point; and calculating, by the computer, a local heat flux at the target point based on the target point temperature and the corresponding ambient temperature.

According to this aspect, it is possible to easily acquire the local heat flux of the target object in the furnace.

### Effect of the Invention

Thus, according to the above aspects, it is possible to easily acquire the local heat flux of the target object in the furnace.

### BRIEF DESCRIPTION OF THE DRAWING(S)

FIG. 1 a configuration diagram of a heat flux acquisition system 1 according to an embodiment

FIG. 2 a block diagram of a heat flux acquisition device 4

FIG. 3 a schematic diagram showing a configuration example in the furnace 2

FIG. 4 a flowchart showing a heat flux acquisition process by the heat flux acquisition device 4

FIG. 5 a flowchart showing a first modification of the heat flux acquisition process shown in FIG. 4

FIG. 6 a flowchart showing a second modification of the heat flux acquisition process shown in FIG. 4

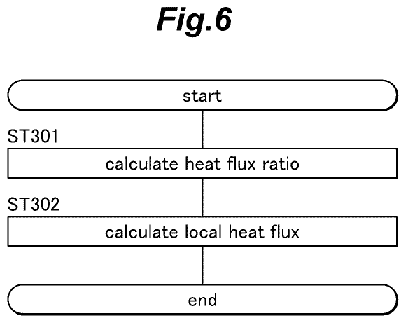

### MODE(S) FOR CARRYING OUT THE INVENTION

In the following, a heat flux acquisition device, a heat flux acquisition system, and a heat flux acquisition method of the furnace according to an embodiment of the present invention will be described with reference to the drawings.

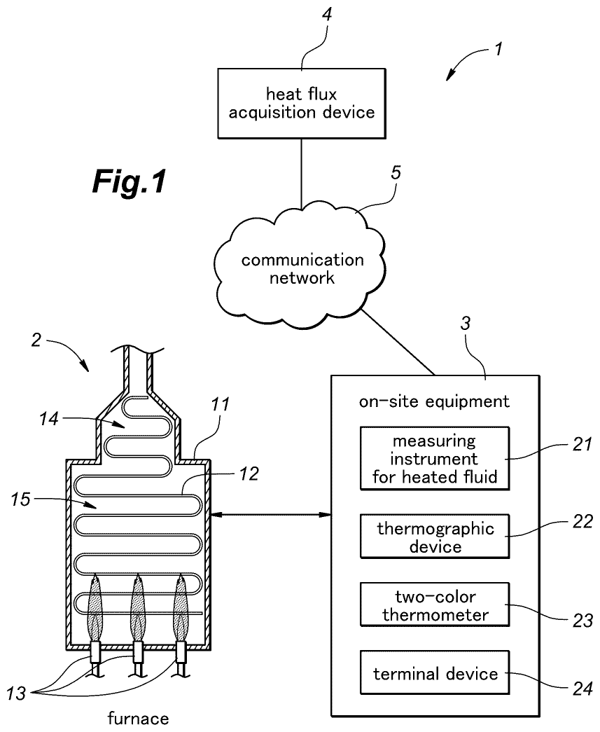

As shown in FIG. 1, a heat flux acquisition system 1 includes an on-site equipment 3 for acquiring various information and measurement data about a furnace 2. The heat flux acquisition system 1 also includes a heat flux acquisition device 4 for acquiring heat flux of a target object in the furnace 2. The on-site equipment 3 and the heat flux acquisition device 4 can communicate with each other via a communication network 5 such as a Local Area Network (LAN) or the Internet. The on-site equipment 3 and the heat flux acquisition device 4 may be connected directly by a communication cable.

The furnace 2 has a known configuration used in plant facilities. Here, the furnace 2 is a tubular furnace, but may have other forms. A heating tube 12 through which a heated fluid flows and a combustion device 13 including a burner are provided in a casing 11 (i.e., in the furnace 2). The heating tube 12 is constituted by a circular tube, but may adopt other shapes. The heating tube 12 is heated by the heat of the flame or combustion gases of the combustion device 13. The furnace 2 includes an upper area 14 in which the heated fluid is heated (or preheated), and a lower area 15 in which the heated fluid that has been heated in the upper area 14 is heated. Although not shown, a plurality of observation windows for observing the inside of the furnace 2 are provided at appropriate positions (for example, on a side wall) of the casing 11.

In the present embodiment, the heating tube 12 that is primarily heated by radiative heat transfer (i.e., thermal radiation) will be described as an example of the object (i.e., the target object) from which the heat flux is acquired in the furnace 2. However, the object from which the heat flux is acquired is not limited to the heating tube 12, but may be other components in the furnace 2 (for example, the inner wall of the casing 11). Furthermore, for example, a slab in the furnace for slab heating may also be employed as the object from which the heat flux is acquired.

The on-site equipment 3 includes a measuring instrument 21 for the heated fluid, a thermographic device 22, a two-color thermometer 23 (an example of a temperature sensor), and a terminal device 24.

The measuring instrument 21 for the heated fluid is attached to appropriate positions of the heating tube 12 (for example, an inlet, an outlet, and an intermediate portion of the heating tube 12 for the heated fluid). The measuring instruments 21 may include a thermometer, a flow meter, and a pressure gauge for measuring the temperature, flow rate, and pressure, respectively, of the heated fluid.

The thermographic device 22 has a known configuration and measures, in a non-contact manner, the outer surface temperature of the heating tube 12 within the prescribed measurement area, based on infrared radiation emitted from the heating tube 12 in the furnace 2. The measurement by the thermographic device 22 is performed through an observation window of the furnace 2. A plurality of thermographic devices 22 may be provided to simultaneously measure a plurality of measurement areas on the heating tube 12.

The two-color thermometer 23 has a known configuration and measures, in a non-contact manner, the temperature of a prescribed position (hereinafter referred to as a target point) on the outer surface of the heating tube 12 (hereinafter referred to as the target point temperature), based on two different measurement wavelengths. The measurement by the two-color thermometer 23 is performed through an observation window, similarly to the thermographic device 22. A plurality of two-color thermometers 23 may be provided to simultaneously measure a plurality of target points on the heating tube 12. The measurement of the target point temperature of the furnace 2 is not necessarily performed by the two-color thermometer 23, but may be performed by another spectral radiation thermometer. In some cases, the target point temperature of the furnace 2 may be measured by a known thermometer (for example, a thermocouple) that is pre-installed in the furnace 2.

The terminal device 24 collects various measurement data measured with respect to the furnace 2. Such measurement data includes data measured by the measuring instrument 21 for the heated fluid, the thermographic device 22, and the two-color thermometer 23. Further, the measurement data may include data acquired by performing the prescribed calculation process using the measured data (i.e., indirectly measured data). The terminal device 24 is communicatively connected to the heat flux acquisition device 4 via the communication network 5 and transmits the collected measurement data to the heat flux acquisition device 4 as appropriate. Further, the terminal device 24 can store specification data of the furnace 2 and transmit the data to the heat flux acquisition device 4. The specification data of the furnace 2 includes data required for calculation processing to acquire the heat flux by the heat flux acquisition device 4 (for example, data related to the physical properties, size, position, or the like of the heating tube 12). The terminal device 24 may be used as a control device for controlling the operation of the furnace 2.

The terminal device 24 consists of a computer provided with known hardware. The terminal device 24 appropriately includes known hardware such as one or more processors, memories, displays, input devices, network interfaces, and storage devices. At least a portion of the functions of the terminal device 24 can be realized by the processor executing the prescribed control program. In the heat flux acquisition system 1, at least a portion of the functions of the above terminal device 24 may be realized by a plurality of computers working together.

Further, as the terminal device 24, a mobile device such as a tablet PC or a smartphone having a communication function carried by a user (for example, an operator or administrator of the furnace 2) of the heat flux acquisition system 1 may be used. Further, at least a portion of the functions of the terminal device 24 (for example, the function of transmitting the measurement data to the heat flux acquisition device 4) may be included in the measuring instrument 21, the thermographic device 22, and the two-color thermometer 23.

In the following, the details of the heat flux acquisition device 4 will be described.

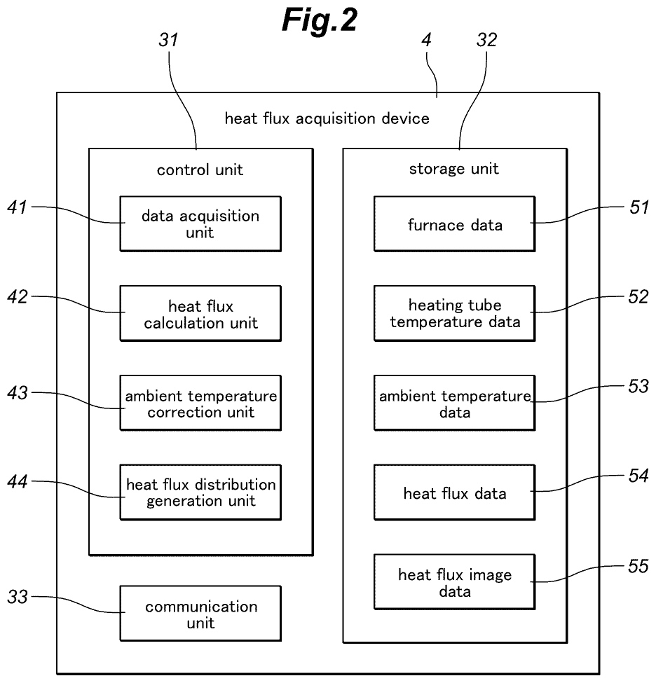

As shown in FIG. 2, the heat flux acquisition device 4 includes a control unit 31, a storage unit 32, and a communication unit 33.

In the control unit 31, a data acquisition unit 41 acquires the measurement data, specification data, and the like related to the furnace 2 received from the terminal device 24 via the communication unit 33. The measurement data acquired by the measuring instrument 21 and the specification data of the furnace 2 are stored in the storage unit 32 as furnace data 51. The measurement data related to the temperature of the heating tube 12 acquired by the thermographic device 22 and the two-color thermometer 23 is stored in the storage unit 32 as a heating tube temperature data 52. The measurement data related to the ambient temperature (i.e., the temperature around the heating tube 12 in the furnace 2) acquired by the thermographic device 22 is stored in the storage unit 32 as ambient temperature data 53. In the furnace 2, the corresponding ambient temperature varies depending on the position of the heating tube 12 (for example, a position relative to the flame of the combustion device 13). As will be described later, the ambient temperature is measured indirectly by the thermographic device 22 (i.e., calculated or estimated based on other measured data).

The furnace data 51 includes position data in the furnace 2. Such position data may include, for example, global coordinate data corresponding to the position of each target point of the heating tube 12. The positions of the measurement points acquired by the thermographic device 22 and the two-color thermometer 23 can also be determined by global coordinates (i.e., the measured temperature or the like can be associated with the global coordinates). As the position data in the furnace 2, coordinate data uniquely set for the furnace 2 may be used.

The heat flux calculation unit 42 calculates the local heat flux at the target point of the heating tube 12 (an example of an estimated local heat flux) based on the heating tube temperature data 52 (here, the target point temperature of each target point) and the ambient temperature data 53 (here, the ambient temperature corresponding to each target point). As will be described later, the heat flux calculation unit 42 may also calculate the local heat flux based on the corrected ambient temperature. Further, the heat flux calculation unit 42 can calculate the average heat flux for the entire heating tube 12 (hereinafter referred to as an estimated average heat flux) based on the local heat flux at a plurality of target points. The estimated average heat flux does not necessarily have to be the heat flux for the entire heating tube 12, but may be the heat flux for the prescribed section of the heating tube 12 (for example, segments G₁-G₉ described later).

Further, the heat flux calculation unit 42 may calculate, instead of or in addition to the estimated average heat flux, the heat input to the entire heating tube 12 (hereinafter referred to as an estimated average heat input) based on the heat input at a plurality of target points.

Further, the heat flux calculation unit 42 can calculate the average heat flux for the entire heating tube 12 (hereinafter referred to as an actual average heat flux) based on the heat quantity of the heated fluid flowing into the heating tube 12 and the heat quantity of the heated fluid flowing out of the heating tube 12 (i.e., the heat input to the heated fluid that has flowed through the heating tube 12). The actual average heat flux does not necessarily have to be the heat flux of the entire heating tube 12, but may be the heat flux for the prescribed section of the heating tube 12 (for example, the segments G₁-G₉ described later).

The heat flux calculation unit 42 may calculate or estimate, instead of or in addition to the actual average heat flux, the heat input to the entire heating tube 12 (hereinafter referred to as an actual average heat input) based on the heat input to the heated fluid that flows throughout the entire heating tube 12. Further, the actual average heat input may be calculated or estimated based on the sum of the heat inputs to the heated fluid that has flowed through each section of the heating tube 12 (for example, the segments G₁-G₉ described later), each of which includes a plurality of target points.

Data related to the local heat flux, the estimated average heat flux, the estimated average heat input, the actual average heat flux, and the actual average heat input calculated by the heat flux calculation unit 42 are stored in the storage unit 32 as heat flux data 54.

As will be described later, the heat flux calculation unit 42 may calculate the heat flux ratio between the actual average heat flux and the respective local heat fluxes at the target points, and store the calculated heat flux ratio in the storage unit 32 as the heat flux data 54. Thereby, even when the operating conditions are changed, the heat flux calculation unit 42 can calculate the local heat flux based on the data on the previously calculated heat flux ratio and the actual average heat flux. The data on the heat flux ratio is stored in the storage unit 32 as part of the heat flux data 54.

The ambient temperature correction unit 43 acquires the corrected ambient temperature by correcting the ambient temperature received from the terminal device 24 based on the estimated average heat flux and the actual average heat flux. The data on the corrected ambient temperature data calculated by the ambient temperature correction unit 43 is stored in the storage unit 32 as the ambient temperature data 53. More specifically, when the corrected ambient temperature is calculated by the ambient temperature correction unit 43, the ambient temperature already stored in the storage unit 32 is updated by the corrected ambient temperature. The ambient temperature correction unit 43 may acquire the corrected ambient temperature by correcting, instead of the ambient temperature received from the terminal device 24, the initial value of the ambient temperature already stored in the storage unit 32.

The heat flux distribution generation unit 44 generates an image (hereinafter referred to as a heat flux visualization image) that visualizes the distribution of the local heat flux at a plurality of target points on the heating tube 12 using color coding (i.e., color changes) based on the data on the local heat flux calculated by the heat flux calculation unit 42. The heat flux visualization image is transmitted to the terminal device 24 and displayed on the display of the terminal device 24. This allows the user to easily confirm various phenomena occurring in the furnace 2 (for example, the occurrence of coking or film boiling in the heating tube 12) based on the heat flux visualization image. Data related to the heat flux visualization image generated by the heat flux distribution generation unit 44 is stored in the storage unit 32 as heat flux image data 55.

When the heat flux distribution generation unit 44 generates the heat flux visualization image, it is preferable that local heat fluxes at a larger number of target points be used. Therefore, the control unit 31 can acquire the measurement data of the temperature from the thermographic device 22 (i.e., the temperature distribution of the heating tube 12 within the prescribed measurement area) corrected using the corrected ambient temperature, and acquire the temperatures in the temperature distribution as the target point temperatures. This enables the control unit 31 to calculate the local heat fluxes at more positions (positions on the outer surface of the heating tube 12 other than the target point measured by the two-color thermometer 23) based on the target point temperatures acquired by measurement by the thermographic device 22 and the corresponding ambient temperatures.

With the above-described configuration, the control unit 31 can execute a process to acquire the heat flux of the heating tube 12 in the furnace 2 (hereinafter referred to as the heat flux acquisition process).

The storage unit 32 may be constituted by hardware such as storage (an example of a storage device) for storing data and information required for the heat flux acquisition process by the heat flux acquisition device 4 as described above.

The communication unit 33 may be constituted by hardware including an antenna, a communication circuit, or the like, for the heat flux acquisition device 4 to communicate with the terminal device 24 and the like via the communication network 5. The control unit 31 can also function as a communication control unit that controls communication with the terminal device 24 and the like by the communication unit 33.

The heat flux acquisition device 4 is constituted by a computer such as a server provided with known hardware. The heat flux acquisition device 4 appropriately includes known hardware such as one or more processors, memories, displays, input devices, network interfaces, and storage devices. At least a portion of the functions of each unit 41-44 in the control unit 31 can be realized by the processor executing the prescribed control program. In the heat flux acquisition system 1, at least a portion of the functions of the heat flux acquisition device 4 described above may be realized by a plurality of computers working together. Further, at least a portion of the functions of the heat flux acquisition device 4 may be included in the terminal device 24.

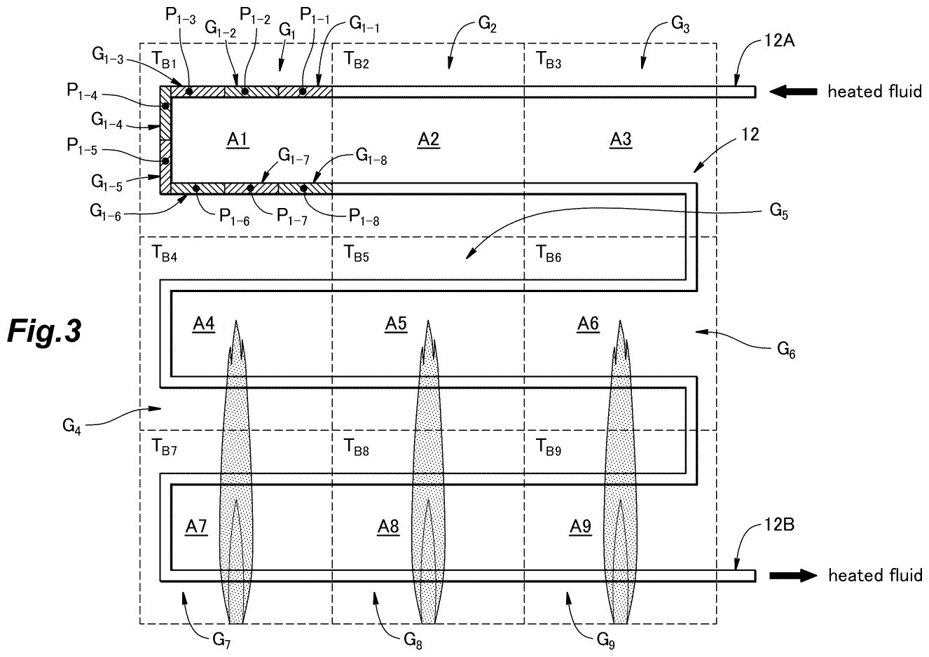

In the following, the details of the heat flux acquisition method by the heat flux acquisition system 1 will be described based on the schematic diagram of the furnace 2 shown in FIG. 3.

As shown in FIG. 3, nine areas A1-A9 are defined in the furnace 2 where the heating tube 12 is arranged. More precisely, the heating tube 12 is arranged in a three-dimensional space, but for the sake of convenience, it is assumed that the heating tube 12 is arranged in the planar rectangular areas A1-A9, as observed from one side of the furnace 2 (for example, the observation window side). The heating tube 12 extends from the upper side to the lower side of the furnace 2 while reciprocating in the lateral direction. The heated fluid flows into the heating tube 12 from the inlet 12A, flows through the heating tube 12 and is heated, and then flows out from the outlet 12B of the heating tube 12. The heating tube 12 and the heated fluid flowing therethrough are heated by the flame or exhaust gas of a burner arranged on the lower side of the furnace 2.

In FIG. 3, the outer surface areas (i.e., the surface areas of the outer circumferential surfaces) of the points of the heating tube 12 in the areas A1-A9 (hereinafter referred to as the segments G₁-G₉, respectively) are defined as S₁-S₉, respectively. The ambient temperatures of the areas A1-A9 corresponding to each segment G₁-G₉ of the heating tube 12 are defined as T_{B1}-T_{B9}, respectively. Further, each segment G₁-G₉ can be divided into a plurality of segments in the longitudinal direction, so that a plurality of subsegments can be set for each segment G₁-G₉. FIG. 3 shows eight subsegments G₁₋₁-G₁₋₈ set for the segment G1 in the area A1 as an example of the subsegments. The target points P₁₋₁-P₁₋₈ of the heating tube 12 may be set, for example, at representative positions of each subsegment G₁₋₁-G₁₋₈ (for example, the center in the longitudinal direction). Further, the target point temperatures T_{R1-1}-T_{R1-8} at the target points P₁₋₁-P₁₋₈ serve as the representative temperatures of the subsegments G₁₋₁-G₁₋₈, respectively. The target points and subsegments are also defined for each of the other areas A2-A9 in the same manner as in the area A1.

The number and size (i.e., range) of the areas, segments, and subsegments set for the furnace 2 are not limited to those shown in FIG. 3 and various modifications may be made. Further, the subsegment may be omitted.

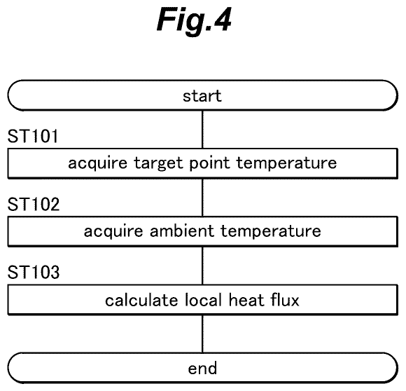

As shown in FIG. 4, in the heat flux acquisition process by the heat flux acquisition device 4, first, for the area A1, the target point temperatures T_{R1-1}-T_{R1-8} measured by the two-color thermometer 23 are acquired at each target point P₁₋₁-P₁₋₈ from which the heat flux is to be acquired (ST101).

Next, the heat flux acquisition device 4 acquires, for each target point P₁₋₁-P₁₋₈, the ambient temperature T_{B1} (an example of the estimated ambient temperature) acquired through tuning during measurement by the thermographic device 22, which will be described later (ST102).

Then, the heat flux acquisition device 4 calculates, for each target point P₁₋₁-P₁₋₈, each local heat flux q₁₋₂-q₁₋₈ based on the target point temperatures T_{R1-1}-T_{R1-8} and the ambient temperature T_{B1} (ST103). For example, the local heat flux q₁₋₁[W/m²] at the target point P₁₋₁ can be calculated from the following formula (1).

$${q}_{1 - 1} = ε \cdot σ ( {T}_{B 1}^{4} - {T}_{R 1 - 1}^{4} ) \qquad ( 1 )$$

Here, each symbol is defined as follows.
T_{R1-1}: outer surface temperature [K] at the target point P₁₋₁ of the heating tube 12
T_{B1}: ambient temperature [K] of the area A1
ε: emissivity of the heating tube 12
σ: Stefan-Boltzmann constant (5.67×10⁻⁸[W/(m²·K⁴)])

The local heat flux q₁₋₂-q₁₋₈[W/m²] at the other target points P₁₋₂-P₁₋₈ can also be calculated in the same manner as the local heat flux q₁₋₁ at the target point P₁₋₁.

The heat flux acquisition device 4 can acquire the local heat flux over the entire length of the heating tube 12 by repeatedly executing the same processes as steps ST101-ST103 described above for the other areas A2-A9.

Here, the acquisition of the ambient temperature in above step ST102 will be described. The radiant energy E(T) [J] of the infrared radiation incident on the thermographic device 22 in measuring the temperature of the heating tube 12 can be expressed by the following formula (2).

$$E ( T ) = ε \cdot E ( {T}_{R} ) + ( 1 - ε ) \cdot E ( {T}_{B} ) \qquad ( 2 )$$

Here, each symbol is defined as follows.
E(T_{R}): radiant energy [J] from the heating tube 12
E(T_{B}): reflected ambient energy [J] at the outer surface of the heating tube 12
T: temperature indication [K] by the thermographic device 22
TR: outer surface temperature (i.e., true temperature) [K] of the heating tube 12
TB: ambient temperature [K]
ε: emissivity of the heating tube 12

The measured value of the two-color thermometer 23 can be used as the outer surface temperature TR of the heating tube 12. The two-color thermometer 23 (i.e., a spectral radiation thermometer) is independent of the emissivity and environmental conditions, and therefore more accurate measurement is possible compared to the measurement by the thermographic device 22.

In the tuning during the measurement by the thermographic device 22, the user can set the ambient temperature TB so that temperature indication T by the thermographic device 22 at a certain target point matches the measured value TRm of the two-color thermometer 23 at the same target point.

For example, for the area A1, the ambient temperature T_{B1} is set so as to minimize the error e expressed by the following formula (3).

$$\begin{matrix}[ number 1 ] & \\ e = {\sum }_{j = 1}^{8} {( {T}_{1 - j} - {T}_{R 1 - j} )}^{2} & ( 3 )\end{matrix}$$

Here, each symbol is defined as follows.
T₁₋ⱼ: temperature indication [K] of the target point by the thermographic device 22
T_{R1-j}: target point temperature

Here, j (=1, 2, . . . , 8) is the subsegment number.

The ambient temperatures T_{B2}-T_{B9} of the other areas A2-A9 can also be set in the same manner as the ambient temperature T_{B1} of the area A1. The set ambient temperatures T_{B1}-T_{B9} are input to the terminal device 24 and transmitted to the heat flux acquisition device 4.

Such tuning during measurement by the thermographic device 22 may be performed automatically without user operation. In this case, the thermographic device 22 can acquire the target point temperatures T_{Ri-j} measured by the two-color thermometer 23, for example, via short-range communication with the two-color thermometer 23.

The local heat flux calculated in the above step ST103 (for example, the local heat flux q₁₋₂-q₁₋₈[W/m²]) is the heat flux value at the prescribed portion in the circumferential direction of the heating tube 12, which is a circular tube. On the other hand, in the heating tube 12, the heat flux and temperature in the circumferential direction may differ depending on the relative position of the heating tube 12 to the flame of the combustion device 13.

The heat flux distribution in the circumferential direction of the tube can be determined based on the tube diameter, tube spacing, and arrangement, for example, according to American Petroleum Institute (API) 530. Similarly, the heat flux at each position in the circumferential direction of the heating tube 12 (i.e., the three-dimensional heat flux distribution) can be acquired by appropriately setting the ratio relative to the local heat flux acquired in ST103. Further, the average local heat flux in the circumferential direction in the prescribed subsegment can be calculated, for example, using the flame surface ratio γ1. If the flame surface ratio in the subsegment G₁₋₁ in the area A1 is γ1, the average local heat flux q₁-lave can be calculated as q₁₋₁/λ1.

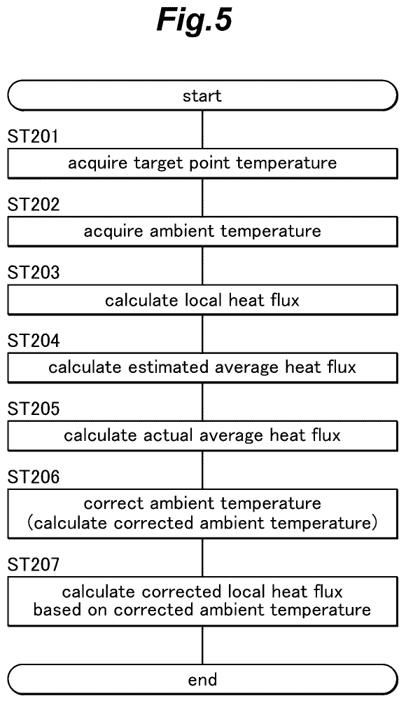

In the following, with reference to FIG. 5, a first modification of the heat flux acquisition process shown in FIG. 4 will be described. In the first modification, unless otherwise specified, matters not specifically mentioned are the same as those in the above heat flux acquisition method.

In the heat flux acquisition process according to the first modification, as shown in FIG. 5, steps ST201 to ST203 similar to steps ST101 to ST103 in FIG. 4 are executed. This acquires the local heat flux over the entire length (i.e., in the areas A1-A9) of the heating tube 12.

Next, the heat flux acquisition device 4 calculates the estimated average heat flux (ST204). In the calculation of the estimated average heat flux, for the area A1, the heat flux acquisition device 4 first calculates the estimated segment average heat flux q₁ₜₒₜₐₗ for the segment G1 based on a weighted average using the outer surface areas S₁₋₁-S₁₋₈ of each subsegment G₁₋₁-G₁₋₈ as weights for the local heat fluxes q₁₋₁-q₁₋₈ at the corresponding target points P₁₋₁-P₁₋₈. Here, the value of q₁₋₁-q₁₋₈ may be the average local heat flux in the circumferential direction described above.

More specifically, the estimated segment average heat flux q₁ₜₒₜₐₗ [W/m²] for the segment G1 can be calculated from the following formula (4).

$$\begin{matrix}[ number 2 ] & \\ {q}_{{1}_{total}} = \frac{{\sum }_{j = 1}^{8} {q}_{1 - j} \cdot {S}_{1 - j}}{{\sum }_{j = 1}^{8} {S}_{1 - j}} & ( 4 )\end{matrix}$$

Here, each symbol is defined as follows.
q₁₋ⱼ: local heat flux [W/m²] at the target point P₁-j
S₁-j: outer surface area of the subsegment G₁₋ⱼ[m²]

Here, j (=1, 2, . . . , 8) is the subsegment number.

The estimated segment average heat flux q₂ₜₒₜₐₗ-q₉ₜₒₜₐₗ for the segments G2-G9 in the area A2-A9 can be calculated in the same manner as the estimated segment average heat flux q₁ₜₒₜₐₗ for the segment G1.

The heat flux acquisition device 4 can calculate the average value of the estimated segment average heat fluxes q₁ₜₒₜₐₗ-q₉ₜₒₜₐₗ as the estimated average heat flux q_{AVG} in the entire heating tube 12.

Next, the heat flux acquisition device 4 calculates the actual average heat flux (ST205). The heat flux acquisition device 4 can calculate the actual average heat flux q_{REAL}[W/m²] from the following formula (5).

$${q}_{REAL} = {M}_{F} \cdot ( {H}_{O U T} - {H}_{I N} ) / {S}_{ALL} \qquad ( 5 )$$

Here, each symbol is defined as follows.
M_{F}: mass flow rate of the heated fluid [kg/s]
H_{IN}: specific enthalpy of the heated fluid flowing into the heating tube 12 [J/kg]
H_{OUT}: specific enthalpy of the heated fluid flowing out of the heating tube 12 [J/kg]
S_{ALL}: entire surface area of the heating tube 12 (=S₁+S₂+ . . . +S₉) [m²]

Next, the heat flux acquisition device 4 corrects the ambient temperature acquired in ST202 so that the estimated average heat flux q_{AVG} in formula (4) matches the actual average heat flux q_{REAL} in formula (5) (ST206). In other words, the heat flux acquisition device 4 calculates the corrected ambient temperature so that the estimated average heat flux q_{AVG} matches the actual average heat flux qREAL.

Further, the heat flux acquisition device 4 calculates the corrected local heat flux based on the calculated corrected ambient temperature in the same manner as step ST202 (ST207).

In this way, the heat flux acquisition device 4 can acquire the local heat flux over the entire length of the heating tube 12.

### <a Modified Method 1>

In the following, a modified method 1, which involves a partial modification of the heat flux acquisition process, will be described. In the modified method 1, unless otherwise specified, matters not specifically mentioned are the same as those in steps ST201 to ST207 in the heat flux acquisition process described above.

In the modified method 1, in the above step ST202, the heat flux acquisition device 4 can set one of the segments G1-G9 (here, the segment G1) as the representative segment, and set the other segments (here, the segments G2-G9) as the subordinate segments. Further, the heat flux acquisition device 4 can set the temperature ratios between the ambient temperatures T_{B2}-T_{B9} corresponding respectively to the subordinate segments G2-G9 and the ambient temperature T_{B1} corresponding to the representative segment G1. Each set temperature ratio is stored in the storage unit 32 as part of the ambient temperature data 53.

For example, the temperature ratio α_{B2} between the ambient temperature T_{B2} corresponding to the subordinate segment G2 and the ambient temperature T_{B1} corresponding to the representative segment G1 can be expressed as the ratio of their fourth powers, as shown in the following formula (6).

$${T}_{B 2}^{4} = {α}_{B 2} \cdot {T}_{B 1}^{4} \qquad ( 6 )$$

Further, the temperature ratios α_{B3}-a_{B9} between the ambient temperatures T_{B3}-T_{B9} corresponding respectively to the other subordinate segments G3-G9 and the ambient temperature T_{B1} can be expressed in the same manner as the temperature ratio α_{B2} for the subordinate segment G2.

This allows the heat flux acquisition device 4, after acquiring the temperature ratios α_{B2}-α_{B9}, by acquiring (or calculating) the ambient temperature T_{B1} of the representative segment G1, to newly calculate the ambient temperatures T_{B2}-T_{B9} of the subordinate segments G2-G9 based on the ambient temperature T_{B1}, even when the operating conditions of the furnace 2 are changed. This reduces the load of the calculation process of the ambient temperature (and therefore the local heat flux) by the heat flux acquisition device 4.

To calculate the local heat flux under the changed operating conditions using the ambient temperature ratio as described above, the ambient temperature of the subordinate segment is calculated based on the ambient temperature of the representative segment and the ambient temperature ratio acquired from the operating data, and then the heat flux at each target point in all segments is acquired using the target point temperature and the ambient temperature at each target point.

In this case, the target point temperature may be a value measured by a temperature sensor or a value calculated by a separate calculation.

Next, calculation method for the target point temperature will be described.

The local heat flux qᵢ₋ⱼ at the target point (segment i, subsegment j) can be expressed by the following formula (7) using the outer surface temperature (i.e., the target point temperature) T_{Ri-j}[K] and the inner surface temperature Tᵣᵢ₋ⱼ[K] of the heating tube 12 at the target point, as well as the thermal resistance Ri-j [m²·K/W].

$${q}_{i - j} = ( 1 / {R}_{i - j} ) \cdot ( {T}_{R i - j} - {T}_{Ii - j} ) \qquad ( 7 )$$

Here, Rᵢ₋ⱼ=R_{Wi-j}+R_{Ri-j}+Rₗᵢ₋ⱼ+(1/hᵢ₋ⱼ), and each symbol is defined as follows. It should be noted that hᵢ₋ⱼ can be acquired based on the API 530.
R_{Wi-j}: thermal resistance of the heating tube=t_{Wij}/λ[m²·K/W] (where t_{Wij} is the tube thickness [m], λ is the tube thermal conductivity [W/(m·K)])
R_{Ri-j}: thermal resistance [m²·K/W] of the scale attached to the outer surface of the heating tube
R_{Ii-j}: thermal resistance [m²·K/W] of the scale attached to the inner surface of the heating tube
hᵢ₋ⱼ: heat transfer coefficient of the flow inside the tube [W/(m·K)]

The inner surface temperature Tri-j [K] corresponds to the temperature of the heated fluid inside the tube at the target point and can be expressed by the following formula (8).

$$\begin{matrix}[ number 3 ] & \\ {T}_{Ii - j} = \frac{{\sum }_{i = 1}^{9} {\sum }_{j = 1}^{8} \text{?} \cdot \text{?} \cdot \frac{1}{γ}}{{M}_{F} \cdot Cp} + {T}_{first} & ( 8 )\end{matrix}$$

$$\text{?} \text{indicates text missing or illegible when filed}$$

Here, each symbol is defined as follows.
qᵢ₋ⱼ: local heat flux [W/m²]
T_{first}: temperature [K] of the fluid to be heated at the time of inflow (initial temperature)
Si-j: surface area [m²] of the pipeline to the target point
γ: flame surface ratio
M_{F}: mass flow rate of the heated fluid [kg/s]
Cp: specific heat [J/(kg·K)]

Based on the above formulae (1) and (7), the following formula (9) holds for the target point P₁₋₁ (i=1, j=1) near the inlet of the heating tube 12. Here, T₁₋₁=T_{first}.

$$\begin{matrix}[ number 4 ] & \\ σε ( {T}_{B 1}^{4} - {T}_{R 1 - 1}^{4} ) = \frac{1}{{R}_{1 - 1}} \cdot ( {T}_{R 1 - 1} - {T}_{first} ) & ( 9 )\end{matrix}$$

Accordingly, it is possible to calculate TR₁₋₁ (the outer surface temperature [K] at the target point P₁₋₁ of the heating tube 12) from formula (9). Moreover, the outer surfaces of the other target points can be calculated in the same manner as the target point P₁₋₁.

### <a Modified Method 2>

In the following, the modified method 2, which involves a partial modification of the heat flux acquisition process, will be described. In the modified method 2, unless otherwise specified, matters not specifically mentioned are the same as those in the heat flux acquisition process described above (see FIG. 5).

In the modified method 2, data on the past operating conditions of the furnace 2 and the ambient temperatures T_{B1}-T_{B9} of each segment G1-G9 under each operating condition are prepared, and the heat flux acquisition device 4 uses these data as training data to construct a machine learning model. The constructed machine learning model is stored in the storage unit 32 of the heat flux acquisition device 4. The machine learning model is not particularly limited, and a known algorithm such as a neural network may be used.

The operating conditions of the furnace 2 include the combustion conditions in the furnace 2 (for example, fuel composition, fuel pressure, fuel flow rate, and the like). The operating conditions may include the operation conditions of each burner (fuel supply (injection) pressure, air volume, and the like) and in-furnace conditions (furnace temperature, flame shape and size).

In the heat flux acquisition device 4, by acquiring data on the current (or the planned) operating conditions of the furnace 2, it is possible to estimate the data on the ambient temperature T_{B1}-T_{B9} for each segment G1-G9 using a machine learning model.

In the modified method 2, the machine learning model may be stored in a server and the like that can communicate with the heat flux acquisition device 4 via the communication network 5. Further, data on the past operating conditions in the furnace 2 and each local heat flux under each operating condition may be prepared, and the heat flux acquisition device 4 may use these data as training data to construct a machine learning model. The heat flux acquisition device 4 may use a machine learning model constructed by another computer or information processing apparatus.

This concludes the description of the specific embodiments, but the present invention is not limited to the above embodiments or modifications, and can be widely modified and implemented. The components of the heat flux acquisition device, the heat flux acquisition system, and the heat flux acquisition method of the project described in the above embodiments are not necessarily essential, and at least those skilled in the art can select the components as appropriate within the scope of the present invention.

### LIST OF REFERENCE NUMERALS

1: heat flux acquisition system
2: furnace
3: on-site equipment
4: heat flux acquisition device
5: communication network
11: casing
12: heating tube
15: lower area
21: measuring instrument
22: thermographic device
23: two-color thermometer
24: terminal device
31: control unit
32: storage unit
33: communication unit
41: data acquisition unit
42: heat flux calculation unit
43: ambient temperature correction unit
44: heat flux distribution generation unit
51: furnace data
52: heating tube temperature data
53: ambient temperature data
A1-A9: area
G₁-G₉: segment
G₁₋₁-G₁₋₈: subsegment

1. A heat flux acquisition device for acquiring heat flux of a target object in a furnace, the heat flux acquisition device comprising a processor configured to execute a process to acquire the heat flux of the target object,
wherein the processor is configured to:
acquire a target point temperature measured by a temperature sensor at a target point on an outer surface of the target object;
acquire an ambient temperature corresponding to the target point; and
calculate a local heat flux at the target point based on the target point temperature and the corresponding ambient temperature,
the furnace is a tubular furnace, and
the target object includes a heating tube of the tubular furnace.

2. The heat flux acquisition device according to claim 1, wherein the local heat flux is calculated based on energy radiated toward the target object, which is calculated based on the ambient temperature, and energy radiated from the target object, which is calculated based on the target point temperature.

3. (canceled)

4. The heat flux acquisition device according to claim 1, wherein the ambient temperature is an estimated ambient temperature estimated based on the corresponding target point temperature in a measurement at the target point by a thermographic device.

5. The heat flux acquisition device according to claim 1, wherein the ambient temperature is a corrected ambient temperature acquired by calculation,
the heating tube includes one or more segments and a plurality of target points set for each segment, and
the corrected ambient temperature is calculated based at least on the target point temperatures measured by the temperature sensor at each target point, heat quantity of heated fluid flowing into the heating tube, and heat quantity of the heated fluid flowing out of the heating tube.

6. The heat flux acquisition device according to claim 5, wherein the processor is configured to:
acquire each target point temperature;
acquire an estimated ambient temperature in the furnace corresponding to each segment, the estimated ambient temperature being estimated based on each corresponding target point temperature;
calculate an estimated local heat flux at each target point based on each target point temperature and the corresponding estimated ambient temperature;
calculate an estimated segment average heat flux or an estimated segment heat input for each segment based on the estimated local heat flux, and acquire an estimated average heat flux or an estimated heat input for the heating tube based on the estimated segment average heat flux or the estimated segment heat input;
calculate an actual average heat flux or an actual heat input for the heating tube based on the heat quantity of the heated fluid flowing into the heating tube and the heat quantity of the heated fluid flowing out of the heating tube; and
calculate the corrected ambient temperature by correcting the estimated ambient temperature so that the estimated average heat flux matches the actual average heat flux, or so that the estimated heat input matches the actual heat input.

7. The heat flux acquisition device according to claim 6, wherein each segment includes a subsegment corresponding to each target point, and
the processor is configured to calculate the estimated segment average heat flux for each segment based on a weighted average using a surface area of each subsegment as a weight for the local heat flux at the corresponding target point.

8. The heat flux acquisition device according to claim 7, wherein the heating tube includes a plurality of segments including one representative segment and a subordinate segment other than the representative segment,
the estimated ambient temperature of the subordinate segment is expressed using a temperature ratio relative to the estimated ambient temperature of the representative segment, and
the processor is configured to:
calculate a corrected ambient temperature of the representative segment so that the estimated average heat flux matches the actual average heat flux, or so that the estimated heat input matches the actual heat input; and
calculate a corrected ambient temperature of the subordinate segment based on the corrected ambient temperature of the representative segment and the temperature ratio.

9. The heat flux acquisition device according to claim 8, further comprising a storage device configured to store the temperature ratio between the estimated ambient temperature of the subordinate segment and the estimated ambient temperature of the representative segment.

10. The heat flux acquisition device according to claim 9, wherein the processor is configured to:
acquire each target point temperature;
acquire the corrected ambient temperature of the representative segment and the corrected ambient temperature of the subordinate segment; and
calculate the local heat flux at the target point based on the target point temperature, and the corresponding corrected ambient temperature of the representative segment and the corresponding corrected ambient temperature of the subordinate segment.

11. The heat flux acquisition device according to claim 10, wherein the processor is further configured to calculate the target point temperature at the target point based on the corrected ambient temperature of the representative segment and the corrected ambient temperature of the subordinate segment.

12. The heat flux acquisition device according to claim 13, further comprising a storage device, wherein the processor is further configured to:
calculate an actual average heat flux for the heating tube based on heat quantity of a heated fluid flowing into the heating tube and heat quantity of the heated fluid flowing out of the heating tube; and
calculate a heat flux ratio between the actual average heat flux and the local heat flux, and store the heat flux ratio in the storage device.

13. The heat flux acquisition device according to claim 12, wherein the processor is configured to:
acquire the heat flux ratio stored in the storage device;
calculate the actual average heat flux for the heating tube based on the heat quantity of the heated fluid flowing into the heating tube and the heat quantity of the heated fluid flowing out of the heating tube; and
acquire the local heat flux based on the heat flux ratio and the actual average heat flux.

14. The heat flux acquisition device according to claim 1, further comprising a storage device, wherein the processor is configured to:
store operating conditions of the furnace and the ambient temperature under the operating conditions in the storage device; and
construct a machine learning model that uses the operating conditions stored in the storage device as input and outputs the ambient temperature.

15. The heat flux acquisition device according to claim 14, wherein the processor is configured to:
acquire the ambient temperature by inputting new operating conditions of the furnace into the machine learning model; and
calculate the local heat flux based on the acquired ambient temperature and the target point temperature on the outer surface of the target object.

16. The heat flux acquisition device according to claim 14, wherein the operating conditions include combustion conditions of the furnace and operation conditions of a burner in the furnace.

17. (canceled)

18. The heat flux acquisition device according to claim 1, wherein the processor is configured to generate an image visualizing a distribution of the local heat flux.

19. The heat flux acquisition device according to claim 6, wherein the heating tube includes one or more segments and a plurality of target points set for each segment, and
the processor is configured to acquire a temperature distribution of the target object measured by a thermographic device using the estimated ambient temperature.

20. The heat flux acquisition device according to claim 19, wherein the processor is configured to acquire a temperature in the temperature distribution of the target object as the target point temperature.

21. (canceled)

22. A heat flux acquisition method for acquiring heat flux of a target object in a furnace, the heat flux acquisition method comprising:
acquiring, by a computer, a target point temperature measured by a temperature sensor at a target point on an outer surface of the target object;
acquiring, by the computer, an ambient temperature corresponding to the target point; and
calculating, by the computer, a local heat flux at the target point based on the target point temperature and the corresponding ambient temperature,
the furnace is a tubular furnace, and
the target object includes a heating tube of the tubular furnace.

23. The heat flux acquisition device according to claim 1, wherein the heating tube includes one or more segments and a plurality of target points set for each segment,
the ambient temperature is set for each segment, and
the local heat flux for each segment is calculated based on the target point temperature of each segment and the ambient temperature of each segment.
